(19) United States
(12) Patent Application Publication
(10) Pub. No.: US 2008/0166632 A1
(43) Pub. Date: Jul. 10, 2008

(54) Method of manufacturing nickel zinc batteries

(75) Inventors: Jeffrey Phillips, La Jolla, CA (US); Jason Zhao, Suisun City, CA (US)

Correspondence Address: BEYER WEAVER LLP, P.O. BOX 70250, OAKLAND, CA, 94612-0250, US

(73) Assignee: PowerGenix, Inc., San Diego, CA (US)

(21) Appl. No.: 11/978,209

(22) Filed: Oct. 26, 2007

Related U.S. Application Data
(63) Continuation of application No. 11/367,028, filed on Mar. 1, 2006.
Application No. 11/367,028 is a continuation-in-part of application No. 10/921,062, filed on Aug. 17, 2004.
(60) Provisional application No. 60/496,208, filed on Aug. 18, 2003.

(51) Int. Cl. H01M 10/36

(52) U.S. Cl. 429/199; 429/207

(57) ABSTRACT

Methods of manufacturing a rechargeable power cell are described. Methods include providing a slurry, paste, or dry mixture of negative electrode materials having low toxicity and including dispersants to prevent the agglomeration of particles that may adversely affect the performance of power cells. The methods utilize semi-permeable sheets to separate the electrodes and minimize formation of dendrites; and further provide electrode specific electrolyte to achieve efficient electrochemistry and to further discourage dendritic growth in the cell. The negative electrode materials may be comprised of zinc and zinc compounds. Zinc and zinc compounds are notably less toxic than the cadmium used in nickel cadmium batteries. The described methods may utilize some production techniques employed in existing NiCad production lines. Thus, the methods described will find particular use in an already well-defined and mature manufacturing base.

### CROSS-REFERENCE TO RELATED APPLICATIONS

This application is a continuation of U.S. patent application Ser. No. 11/367,028 [Atty Docket No. PWRGP001X1], filed on Mar. 1, 2006, which is a continuation in part of U.S. patent application Ser. No. 10/921,062 [Atty Docket No. PWRGP001], filed Aug. 17, 2004, which claims benefit of U.S. Provisional Application No. 60/496,208, filed Aug. 19, 2003. This application also claims benefit of U.S. Provisional Patent Application No. 60/657,825 [Atty Docket No. PWRGP001X1P], filed Mar. 1, 2005 under 35 USC 119(e). This application is also related to U.S. patent application Ser. No. 11/116,113 [Atty Docket No. PWRGP030], filed May 26, 2005 and to U.S. patent application Ser. No. 11/346,861 [Atty Docket No. PWRGP031], filed Feb. 1, 2006. Each of these patent applications is incorporated herein by reference for all purposes.

### BACKGROUND

1. Field of the Invention

The present invention relates to the rechargeable battery arts and, more particularly to the manufacture of nickel zinc rechargeable battery cells.

2. Description of the Related Art

The advent of portable communication and computation devices that allow diverse mobile connectivity has fueled growth and innovation in the rechargeable battery field. Increased capacity and power has made possible the entry of rechargeable power sources in various fields including the power tool arena. Because power tools typically have large current demands, rechargeable power sources have necessarily evolved to accommodate rapid discharge characteristics. It can be appreciated that the present invention will also find use in applications other than power tools such as Uninterruptible Power Supplies (UPS), Electric Vehicles, and high demand consumer electronics—all of which require high carrying capacity and current discharging ability. Of course, the invention also applies to relatively lower discharge rate applications such as many mainstream consumer electronics applications.

Rechargeable power sources have various benefits over non-rechargeable sources. For example, the use of non-rechargeable power sources raises growing environmental concerns with respect to hazardous waste disposal and remediation. In light of the proliferation of portable devices, the number of non-rechargeable power sources needed to use those devices would be staggering. Rechargeable power sources allow a battery cell to be used repeatedly thus reducing the introduction of hazardous waste products into the environment. Further, rechargeable power sources allow the conservation of the metal and chemical resources that would otherwise be spent in non-rechargeable power sources. Finally, the use of rechargeable power sources encourages and expands continuing conservation efforts that are necessary for a growing population to embrace.

Although the benefits of rechargeable power sources are many, they are not without costs. In particular, the materials that comprise rechargeable power sources frequently pose a significant potential threat to the environment. Regional recycling agencies like the Northeast Recycling Council (NERC) are actively addressing the problems of disposal of rechargeable power sources. In a recent report by NERC, nine of the ten member states banned the disposal of lead acid batteries; six of the ten banned the disposal of Nickel/Cadmium batteries; and four of the ten banned the disposal of mercuric oxide batteries (http://www.nerc.org/documents/recyclingrules0901.html). The EPA has also weighed in and has recently closed feedback on industry wide practices for disposal of NiCad batteries stating,
NiCad batteries, commonly used in industrial and household appliances such as cordless phones, power tools and laptop computers, are one of a number of products that pose a potential environmental risk when disposed of incorrectly. The batteries contain both Nickel and Cadmium, the most toxic component, and can cause health problems when not disposed of properly. They are both heavy metals and can also adversely affect the environment during recycling and disposal. (http://www.epa.nsw.gov.au/media/0403/eprbatteries.htm)

Because of the hazardous nature of some of the commonly used materials for conventional rechargeable power sources, it would be desirable to manufacture a rechargeable power source that reduces the quantity of any potentially hazardous materials. In particular, it would be desirable to find a substitute for the widely used nickel cadmium battery cell.

It has been found that rechargeable nickel zinc cells can provide a power-to-weight and a power-to-volume ratio that exceeds nickel cadmium cells and lithium ion cells at a reasonable cost. However, nickel zinc battery technology has not been widely deployed for at least two reasons. First, it has been found to have a relatively limited cycle life. In other words, a given nickel zinc cell can only charge and discharge for a fraction of the cycles typically attained with a comparable nickel cadmium cell. This is due to zinc distribution and dendrite formation. Second, there has not been a suitable high volume manufacturing process developed for nickel zinc batteries.

It would be desirable to use, to the extent possible, existing manufacturing techniques to produce environmentally safer rechargeable power sources in order to leverage the existing manufacturing infrastructure rather than require a wholly new manufacturing base.

### SUMMARY OF THE INVENTION

The present invention accomplishes the advantages described above by employing a nickel-cadmium type manufacturing process with certain important variations that allow for replacement of the cadmium negative electrode with a less deleterious negative electrode, such as an electrode fabricated from zinc or a zinc compound such as zinc oxide or calcium zincate. Various methods of manufacturing a cadmium-free power cell are described herein. The methods employ high volume lines for nickel and zinc electrode fabrication. As part of the manufacturing process, slurries, pastes, or dry powders of negative and positive electrode materials are continuously coated onto a carrier sheet.

The positive electrode material preferably has a composition similar to that employed to fabricate the nickel electrode in a conventional nickel-cadmium battery, although there may be some important optimizations for the nickel zinc battery system. The negative electrode preferably employs zinc oxide and zinc metal or an alloy thereof as an electrochemically active material. In some embodiments, the negative electrode includes other materials such as bismuth oxide, indium oxide, and/or aluminum oxide. The carrier for the negative electrode (which serves as a current collector) should be electrochemically compatible with the negative electrode materials. For a zinc electrode, for example, the carrier material is preferably copper or an alloy of copper in the form of a perforated sheet or an expanded metal.

In one embodiment employing a wet process, the negative electrode materials include dispersants to minimize agglomeration of zinc oxide particles, as agglomeration has been found to adversely affect the performance of nickel zinc cells. In further embodiments, the methods employ multiple sheets (e.g., four) of separator material that separate the electrodes and minimize formation of zinc dendrites. Examples of suitable separator materials include nylon sheets and microporous polyolefin sheets. Further, the fabrication methods of this invention preferably make use of a high conductivity electrolyte that discourages dendritic growth in the zinc electrode.

Importantly, the fabrication methods produce cells having a zinc negative electrode, yet they utilize certain production techniques heretofore reserved for other cell types. In particular, existing nickel cadmium production lines may be utilized with minor modifications to accommodate the methods described herein. In one example, the method employs the following sequence: coating positive and electrode current collector sheets with pastes or slurries of positive and negative electrode materials, drying and compressing the nascent electrode sheets, cutting and cleaning the sheets, and forming a “jelly roll” cell assembly from the cut electrode sheets and interleaved microporous separator sheets. The methods described will find particular use in an all ready well-defined and mature manufacturing base.

Additionally, methods and cell designs are disclosed to increase the efficiency of the rechargeable power cells by reversing the polarity of the cell such that he terminals are reversed in comparison to conventional methods of manufacture.

Certain embodiments employ dry processes in which relatively dry powders or granular mixtures of the electrode components are employed in place of slurries or pastes. The electrode compositions employed in these dry processes need not include dispersants or other additives normally provided to improve the consistency of a slurry or paste.

Certain dry processing methods of manufacturing a rechargeable power cell may be characterized by the following sequence of operations: (a) applying a zinc negative electrode material to a first conductive carrier to form a first electrode sheet; (b) applying a nickel positive electrode material in a substantially dry state to a second conductive carrier to form a second electrode sheet; (c) disposing at least one separator sheet between the first electrode sheet and the second electrode sheet such that the first electrode and the second electrode sheets and the at least one separator sheet form are layered to form a cell assembly; and (d) winding or folding the cell assembly to form a three-dimensional structure having a form factor generally corresponding with that of the rechargeable power cell. In some embodiments, the negative electrode material may be applied to the first conductive carrier in a substantially dry state. Alternatively, it may be applied as a paste or slurry. The rechargeable power cell may have any form factor including various forms of cylindrical and prismatic cells.

One benefit of dry processing is that the nickel positive electrode material may be produced substantially free of dispersant and organic pasting aids. Still, in certain embodiments, the nickel positive electrode material will include a binder such as a fluorinated polyolefin. In certain embodiments, the binder is present in the nickel positive electrode material at a level of between about 0.1 and 5 percent by weight. In a specific example, the positive electrode material includes a nickel hydroxide and/or oxyhydroxide, a zinc oxide, a cobalt oxide, and a binder. In certain embodiments, the negative electrode material is comprised of a zinc oxide, zinc or a zinc alloy, a bismuth oxide, and an aluminum oxide. In some cases, the negative electrode may also include a binder and/or a dispersant, which reduces agglomeration of particles. Preferably, the negative electrode has a low carbonate content; e.g., it may employ a zinc oxide having at most about 1% by weight carbonate. Carbonate may also be driven off by heating the negative electrode to a temperature of at least about 200 C. Such heating may have other beneficial effects.

In certain embodiments, the first conductive carrier is made from copper or an alloy of copper. In some examples, the first conductive carrier may include perforated copper or an alloy of copper or expanded copper or an alloy of copper. In certain embodiments, the second conductive carrier is made from nickel such as a sheet of nickel foam.

In certain embodiments, the method also includes the following operations: (e) attaching a first internal terminal with a first end of the cell assembly such that only the negative electrode is in electrical communication with the first internal terminal; (f) attaching a second internal terminal with a second end of the cell assembly such that only the positive electrode is in electrical communication with the second internal terminal; (g) inserting the cell assembly into a retaining vessel; (h) filling the retaining vessel containing the cell assembly with an electrolyte; and (i) sealing the retaining vessel such that the electrolyte and the cell assembly is substantially isolated from the environment. A variant or species of this method involves attaching a cell cap terminal to the first internal terminal and inserting the cell assembly into a retaining vessel and attaching the second internal terminal to the retaining vessel, such that the cell has a negative cap. The method may also include the following: initially charging the rechargeable power cell according to a defined charging curve; and individually testing the rechargeable power cell such that the rechargeable power cell is grouped by charge/discharge similarities.

Another aspect of the invention pertains manufacturing methods characterized by the following operations: (a) applying a zinc negative electrode material to a first conductive carrier to form a first electrode sheet; (b) applying a nickel positive electrode material to a second conductive carrier to form a second electrode sheet; (c) disposing at least one separator sheet between the first electrode sheet and the second electrode sheet such that the first electrode and the second electrode sheets and the at least one separator sheet form are layered to form a cell assembly; (d) winding or folding the cell assembly to form a three-dimensional structure having a form factor generally corresponding with that of the rechargeable power cell; and (e) compression bonding a first internal terminal to a first end of the cell assembly such that only the negative electrode is in electrical communication with the first internal terminal. The bonding may also be accomplished by soldering a first internal terminal to a first end of the cell assembly such that only the negative electrode is in electrical communication with the first internal terminal. In this approach, prior to the soldering, the first internal terminal may be provided with solder coating.

Regardless of what type of bonding is employed, various additional features may be associated with the methods. These include all those stated above for the dry processing procedure. Further, the method may employ internal terminals that take the form of a perforated disk, a slotted disk, or an H-shaped structure. In certain embodiments, the first internal terminal is maintained in compression with the first end of the cell assembly by a downward force provided by a cell cap in a fully assembled rechargeable power cell. Such force may be provided by an elastomeric member or a spring device interposed between the cell cap and the internal terminal.

### BRIEF DESCRIPTION OF THE DRAWINGS

The invention may be understood more fully by reference to the following description taken in conjunction with the accompanying drawings in which:

FIG. 1 is a diagrammatic representation of the process flow of an embodiment of the present invention.

FIG. 2 is a further diagrammatic representation of the process flow of an embodiment of the present invention.

FIG. 3 is a graphical cross-sectional representation of the cathode and anode prior to winding.

FIG. 4a is a graphical representation of a reverse polarity power cell sub assembly embodiment.

FIG. 4b is a graphical cross-sectional representation of a reverse polarity power cell sub assembly embodiment.

It is to be understood that, in the drawings, like reference numerals designate like structural elements. Also, it is understood that the depictions in the figures are not necessarily to scale.

### DETAILED DESCRIPTION OF THE PREFERRED EMBODIMENTS

The present invention relates generally to techniques for the manufacture of nickel-zinc rechargeable battery cells using techniques similar to generally accepted production techniques for nickel-cadmium rechargeable power cells.

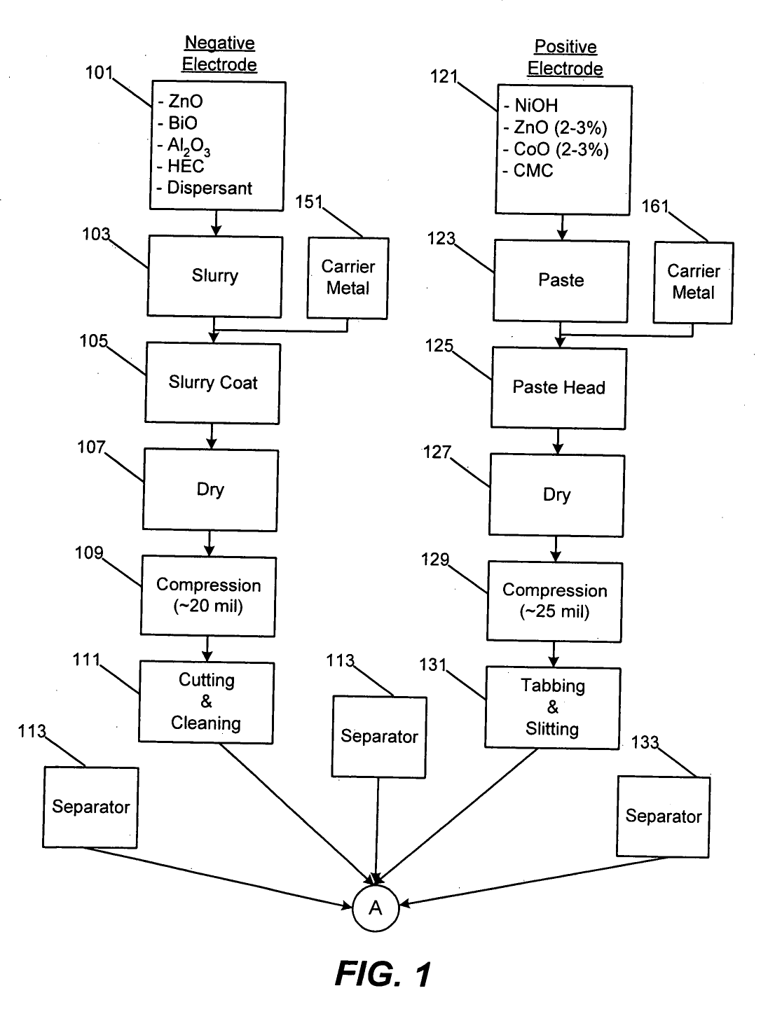

Embodiments of this aspect of the invention are discussed below with reference to FIGS. 1-4b. However, those skilled in the art will readily appreciate that the detailed description given herein with respect to these figures is for explanatory purposes as the invention extends beyond these limited embodiments.

Turning first to FIG. 1, FIG. 1 presents a diagrammatic representation of a manufacturing process flow for an embodiment of the present invention. Initially, the process includes two separate paths, one for fabricating a negative electrode sheet and the other for fabricating a positive electrode sheet. Eventually, in the process described, these two paths converge when the separate negative and positive electrodes are assembled into a single cell. Typically, the process steps of these two paths are performed in parallel, within a single plant, so that the electrodes can be continuously formed as sheets that are then continuously combined in the process of forming nickel zinc cells in accordance with this invention.

Blocks 101 and 121 depict example starting materials for the positive and negative electrodes. These blocks represent the fact that the manufacturing process must begin by providing the requisite starting materials for creating electrodes. In addition to the raw electrode formulation materials, the process will also require electrode carrier sheets (comprised of conductive material that ultimately serves as the current collectors in the assembled cells) as well as separator sheets for separating the positive and negative electrodes in the assembled cells, electrolyte, water to form electrode pastes or slurries if these are employed in the process, and cell packaging materials (e.g., disk terminals, a cell can, etc.).

Considering the negative electrode first, the manufacturing process begins by providing the negative electrode materials (101) required to form the negative electrode. In the example embodiment shown in FIG. 1, negative electrode materials (101) include zinc metal, ZnO, Bi₂O₃, Al₂O₃, HEC, and dispersant. Indium oxide is also included in some embodiments. Various other formulations are possible, including those that employ other forms of zinc, such as calcium zincate or precursors thereof (e.g., calcium oxide and zinc oxide). Other electrode formulations include various inorganic fluorides, inorganic fibers such as alumina-silica fibers, and organic fibers such as cotton flock etc. Still others employ no HEC, dispersant or other organic material.

As noted above, the invention is generally directed to methods of manufacturing nickel zinc batteries. As such, the negative electrode materials are based on zinc and zinc compounds, which are significantly less hazardous than the more commonly used cadmium compounds. The EPA has classified zinc and zinc compounds in Group D indicating inadequate evidence as to its carcinogenic potential (U.S. EPA, 1995a). Further, the International Agency for Research on Cancer (IARC) has not classified zinc as to its carcinogenic potential (IARC, 1987a). In contrast, epidemiological evidence strongly supports an association between cadmium exposure and neoplasia, including respiratory and renal cancers (ARB, 1986c). Further, the EPA has classified cadmium in Group B1: Probable human carcinogen, based on human and animal studies showing an increase of lung cancer (U.S. EPA, 1994a). Further, the IARC has classified cadmium and cadmium compounds in Group 1: Human carcinogen based on epidemiological evidence of carcinogenicity in humans and carcinogenic effects observed in animals (IARC, 1993b).

As indicated, zinc oxide is a suitable electrochemically active material for use in the negative electrode. Other zinc compounds having may be utilized as well. In particular, another example embodiment, calcium zincate (CaZn(OH)₄), may be used as a starting material in place of ZnO. It can be appreciated that producing calcium zincate can comprise potentially damaging exothermic reaction. The reaction is also strongly dehydrating and can be difficult to control during generation of a slurry or paste for manufacturing the negative electrode. Therefore, if calcium zincate is to be used, it should at least be partially pre-formed ex situ. Only then should it be added to the mixture of negative electrode materials. A general procedure for using calcium zincate in this manner is described in PCT Patent Application No. CA02/00352 (International Publication No. WO 02/075825) by inventor J. Phillips, filed Mar. 15, 2002, which is incorporated herein by reference for all purposes.

Other suitable electrochemically active materials for use in the negative electrode are zinc metal and zinc alloys. Preferably, the size of the zinc metal or alloy particles is relatively small; e.g., less than about 50 microns average diameter; more preferably less than about 45 microns average diameter; and even more preferably less than about 40 microns average diameter. In a specific embodiment, the zinc material has a particle size distribution characterized in that 92% by weight of the material has a particle size of less than 45 microns and 8% by weight of the material has a particle size of greater than 45 microns. Various alloying elements may be employed in the zinc alloys. Examples include indium and bismuth, with lead and iron also being suitable in some cases. Preferably, the indium and/or bismuth concentration does not exceed 1% of the total alloy mass. In some embodiments, the alloy contains up to about 500 ppm indium and up to about 500 ppm bismuth. In some embodiments, the alloy may contain up to about 25 ppm lead and/or up to about 5 ppm iron.

It has been found that a high temperature “burn out” procedure can improve the high rate performance of the resulting zinc electrode. In a typical approach, zinc oxide is heated to a temperature of between about 200 and 400° C., preferably between about 300° C. and 380° C. (e.g., about 320° C.) for a period of between about 0.5 and 2 hours in an inert atmosphere or under vacuum (to limit oxidation of underlying copper current collectors). The burn out procedure may remove dispersion agents and other organic materials believed to have a detrimental effect on high rate discharge of zinc electrodes. Alternatively, or in addition, the burn out procedure may remove carbonate, which may impede high rate discharge. It may reduce the conductivity of the electrolyte by, possibly, depleting hydroxide from the electrolyte and/or reducing the transport capability of the electrolyte. Unfortunately, zinc oxide readily reacts with carbon dioxide in the ambient to form zinc carbonate. Hence the surface of zinc oxide particles exposed to the ambient can gradually attain relatively high amounts of carbonate. Many commercial sources of zinc oxide have significant carbonate content. To mitigate this problem, it may be desirable to heat the zinc oxide and drive off carbon dioxide prior to electrode manufacture. In a preferred embodiment, the zinc oxide used to manufacture negative electrodes contains not greater than about 1 percent by weight of carbonate. It has been found that zinc metal components can withstand oxidation during the burn out procedure. Only a relatively small percentage of the zinc is converted to oxide during burn out during exposure to the atmosphere.

In some embodiments, the zinc electrode is formed from a slurry or paste of zinc oxide and other electrode materials. In other embodiments, the zinc electrode is formed by a dry process, in which the electrode components are provided as a powdered mixture that is compressed on current collector or other carrier. As will be explained more fully below, the dry process may not require a dispersant or other organic material that can negatively impact performance.

In addition to the zinc oxide or other electrochemically active zinc source, the negative electrode mixture may include other materials that facilitate certain processes within the electrode such as ion transport, electron transport, wetting, porosity, structural integrity, active material solubility, etc. In wet processes, other additives control the consistency for flow and other process-relevant properties of the slurry or paste itself. In a specific embodiment, the negative electrode slurry includes zinc alloy, bismuth oxide, aluminum oxide, hydroxyethyl cellulose (HEC), and a dispersant.

Hydroxyethyl cellulose (HEC) may be used to control the consistency of the slurry or paste of negative electrode materials. HEC is a nonionic, water-soluble polymer that can thicken, suspend, bind, emulsify, form films, stabilize, disperse, retain water, and provide protective colloid action. It is readily soluble in hot or cold water and can be used to prepare solutions with a wide range of viscosities. Also, it has outstanding tolerance for dissolved electrolytes. Hence, HEC or other material with related properties is used in certain embodiments to force the negative electrode materials (in its paste form) to retain water.

In one approach to forming a negative electrode slurry, two separate mixtures are produced and then combined to form the slurry. The first mixture comprises water and HEC (or other suitable material) and the second mixture comprises water and pre-sieved solids (e.g., zinc metal or zinc alloy, ZnO, Al₂O₃, Bi₂O₃, and dispersant).

Other negative electrode compositions are described in the following documents, each of which is incorporated herein by reference: PCT Publication No. WO 02/39517 (J. Phillips), PCT Publication No. WO 02/039520 (J. Phillips), PCT Publication No. WO 02/39521, PCT Publication No. WO 02/039534 (J. Phillips), and U.S. patent application Ser. No. 10/098,195 filed Mar. 15, 2002. Among the negative electrode additives described in these references are silica and fluorides of various alkaline earth metals, transition metals, heavy metals, and noble metals.

As indicated, the manufacturing process preferably employs low carbonate zinc oxide. Unfortunately it has been found that low carbonate zinc oxide agglomerates in suspension much more readily than the typical higher carbonate oxide. Hence it has been found difficult to produce negative electrodes with well mixed, evenly dispersed components in wet compositions, as the zinc oxide tends to form agglomerates. To address this problem, certain embodiments employ a dispersant to minimize agglomeration of low carbonate zinc oxide particles. Generally, a dispersant modifies the surface properties of particles to facilitate dispersal throughout a slurry or other suspension. Many dispersants are conventional surfactants or variations thereof tailored for the surface properties of particular particles to be dispersed. As zinc oxide is widely used in the paint industry, various dispersants for the oxide have been developed. One such dispersant is commercially available as NOPCOSPERSE 44 by San Nopco Ltd. of Kyoto Japan. The dispersant, in sufficient quantity, has been found to coat the surface of the zinc oxide particles thus eliminating the agglomeration of zinc oxide particles in manufacturing processes of this invention.

Returning to FIG. 1, the negative electrode materials (101) are combined as described above to form a water-based slurry (103) and continuously applied to a conductive carrier sheet (151) as a slurry coat (105). It can be appreciated by one skilled in the art that the material may also be made into a paste and continuously applied via a paste head as in step 125 for the formation of the negative electrode. In a specific example, the paste head applies negative electrode paste mix at a pressure of approximately 3 psi (pounds per square inch) to both sides of the carrier sheet. If slurry coating is employed, a conventional slurry coating apparatus may be used. In such apparatus, a continuous supply of slurry is provided to a chamber through which the carrier sheet passes.

Note that conventional zinc electrodes are formed by vacuum techniques that draw paste or slurry onto the carrier of the negative electrode. In some cases, where calcium and zinc oxides have been used as the active material, a petroleum-based additive is employed to promote fibrillation of Teflon that facilitates the production of an electrode sheet that may be pressed onto the carrier.

In some embodiments, the zinc electrode components are provided as a dry mixture. In other words, these embodiments do not employ a slurry, paste or other wet composition. In a dry mixture, the electrode components are provided as a powder or granular mixture that is relatively free of water or other liquid medium. Hence, the electrode mixture will not flow in the manner of a paste or slurry and therefore will not be delivered via a paste head or related mechanism.

Dry processing is amenable to electrode mixtures employing metal additives such as zinc or zinc alloys, which can effervesce and negatively impact the consistency of a paste or slurry. Further, dry processing does not require use of certain organic materials such as dispersants and paste consistency additives, e.g., HEC. As mentioned above, these additives can negatively impact the performance of nickel-zinc cells.

In one example, the zinc electrode mixture employed in a dry process includes a source of electrochemically active zinc and an oxide such as aluminum oxide, bismuth oxide, and/or indium oxide. Other additives many include various inorganic fluorides, inorganic fibers such as alumina-silica fibers, and organic fibers such as cotton flock etc. The source of electrochemically active zinc may be zinc oxide, zinc metal, alloys of zinc metal, calcium zincate or precursors thereof (e.g., calcium oxide and zinc oxide), partially oxidized zinc metal, and combinations thereof. For zinc alloys, examples of alloying elements include indium and bismuth. One particular embodiment employs a zinc metal or zinc metal alloy powder that has been partially oxidized to zinc oxide. The resulting partially oxidized metal is combined with an oxide and a suitable binder such as dry polytetrafluoroethylene (P.T.F.E.) powder as described above and applied to the negative electrode carrier material.

The dry powder zinc process involves feeding the powder at a controlled rate into compression rollers together with a three-dimensional electrochemically compatible substrate such as reticulated copper foam or expanded copper metal such that the powder is retained and compressed to the appropriate porosity.

It can be appreciated that any of a number of carrier materials may be used to form the positive electrode including, but not limited to, nickel, nickel plated steel, silver, and the like. One skilled in the art will understand that the carrier sheet serves as the current collector for the negative electrode in the finished nickel zinc cell. Copper and copper alloys are particularly preferred materials for the carrier sheet given copper's low resistivity, relatively low price, and electrochemical compatibility with the zinc electrode. Notably, nickel plated steel is the carrier of choice for the cadmium electrode in commercial nickel cadmium cells.

The carrier sheet can be provided in various structural forms including a perforated metal sheet, an expanded metal, and a metal foam. Among the criteria employed to select a particular structural form are cost, ease of coating, and ability to facilitate electron transport between the electrochemically active electrode material and the current collector. In a preferred embodiment, the thickness of the carrier is between about 2 and 5 mils for perforated sheet but may be between 2 and 20 mils for expanded metal. Metal foam substrates may be between 15 and 60 mils.

Once the negative electrode is coated, it is dried (107) in the case of a wet process to drive off excess water used as a delivery medium for the electrode material. A thermal drier employing flowing air or nitrogen may be employed for this purpose.

The resulting negative electrode is then compressed (109) using a roller or other appropriate compression mechanism. As can be appreciated by one skilled in the art, compression brings the electrode to a uniform thickness so that manufacturing tolerances may be maintained. Compression also brings the negative electrode to a desired porosity. It can be appreciated that porosity controls the transport properties of ions between electrolyte and electrode. Porosity also dictates the active surface area and hence the current density of the negative electrode. In a typical example, the post-compression thickness of the negative electrode is between about 10 and 40 mils (e.g., about 20 mils) and the porosity is between about 40 and 65%.

After compressing the electrode sheet by an appropriate degree, it may be cut and cleaned at a step 111. Note that the carrier sheet typically has a width significantly greater than that required for a single battery cell; e.g., the width may be on the order of one yard. Therefore, the negative electrode is cut to a width conforming to end-product specific tolerances (e.g., approximately 1.25 inches for a sub C size cell for example). A portion of the cut negative electrode may be “cleaned” prior to further assembly. In particular, a strip of the negative electrode material along the edgewise length of the negative electrode is removed. The cleaned strip facilitates the attachment of a terminal to the negative electrode current collector at a further step 203 by exposing the underlying current collector metal. While other methods of terminal attachment may be accomplished, cleaning leaves a surface that is particularly well suited to soldering, spot welding, or any other type of electro-conductive bonding known in the art. As can be appreciated by one skilled in the art, cleaning the electrode may be accomplished by any of the following methods without limitation: scraping, scouring, grinding, washing, and wiping. This is typically achieved in combination with a vacuum clean up to eliminate particulate matter.

In like manner, as discussed above for the negative electrode, the positive electrode may be formed. Beginning at an initial step 121, positive electrode materials are provided to form the positive electrode. In an example embodiment employed in a wet process and as shown in FIG. 1, the positive electrode materials (121) comprising nickel hydroxide (Ni(OH)₂), zinc oxide, cobalt oxide (CoO), nickel metal, optionally cobalt metal, and optionally a flow control agent such as carboxymethyl cellulose (CMC) are provided. In a preferred embodiment, at least some of the zinc oxide and cobalt oxide are provided with the nickel hydroxide in a chemical mixture, whereby individual particles contain nickel hydroxide, zinc oxide and cobalt oxide. Such premixed materials may be prepared by co-precipitation of the individual components and may be acquired in a commercially available formula from commonly known vendors such as International Nickel Corporation, and Tanaka. These materials prevent leaching by locking the oxides into the insoluble nickel matrix. Co-precipitation also apparently helps charge transfer efficiency by creating conductive channels through the positive electrode materials. In a preferred embodiment, the zinc oxide and cobalt oxide are each present in the co-precipitated material in concentrations of about 2-3% by weight for the zinc and about 2-6% for the cobalt oxide. Further, the positive electrode materials may additionally include chemically pure cobalt and nickel metal.

If cobalt metal is employed in the positive electrode, it is preferably present in a concentration of between about 1% to 10% by weight. This concentration range is appropriate for a wide range of discharge rates (e.g., about 0.001 to 0.4 Amperes/cm² of zinc electrode surface area). In a typical high rate application (e.g., discharge is conducted at about 0.01 to 0.4 Amperes/cm² of zinc electrode surface area), the concentration of cobalt metal is between about 4-10% by weight in the positive electrode. In a typical low rate application, the concentration of cobalt metal is between about 1-5% by weight, and the discharge is conducted at about 0.001 to 0.01 Amperes/cm² of zinc electrode surface area.

In alternate embodiments, cobalt oxide may be added to the material to enhance conductivity at operation 121. However, it is generally preferred that the starting materials include little or no additional cobalt oxide. Note that in commercial nickel cadmium cells, free cobalt oxide is commonly employed in the positive electrode mixture.

In one approach, a positive electrode paste is formed from two separate mixtures: one that includes CMC (carboxymethylcellulose) and water and another that includes water and the co-precipitated nickel hydroxide-cobalt oxide-zinc oxide, nickel metal, and relatively pure cobalt oxide. These two mixtures are then combined to form the positive electrode paste. Note that the CMC is included to improve flow characteristics for the resulting paste at step 123.

A few positive electrode compositions are described in the following documents, each of which is incorporated herein by reference: PCT Publication No. WO 02/039534 (J. Phillips) (co-precipitated Ni(OH)₂, CoO and finely divided cobalt metal) and U.S. patent application Ser. No. 10/098,194 filed Mar. 15, 2002 (fluoride additives).

At block 125, the paste is continuously applied to a positive electrode carrier sheet via a paste head. It can be appreciated that any of a number of carrier metals may be used to form the negative electrode so long as they meet appropriate design criteria such as low cost, high conductivity, electrochemical compatibility with the positive electrode, and good contact with the electrochemically active material. Examples include, but not limited to, nickel and nickel-plated stainless steel. The carrier metal may possess one of various structural forms including perforated metal, expanded metal, sintered metal, metal foam and metal-coated polymer materials. In a preferred embodiment, the carrier is a nickel metal foam formed by, for example, pyrolyzing a urethane foam on which nickel was electrolytically deposited. The thickness of the foam positive electrode carrier after undergoing a prepress to ensure thickness uniformity is between about 15 and 60 mils, for example.

As with the negative electrode, the positive electrode can be prepared using a dry process. In this approach, the CMC and certain other organics are not used. Note that in some embodiments, it is not feasible burn off organics from the positive electrode mixture. Hence a dry process that is relative free of organics can provide significant advantages, particularly in the context of a nickel-zinc cell employing an electrolyte having a relatively low hydroxide concentration. In a specific embodiment, the positive electrode composition for a dry process includes nickel hydroxide, zinc oxide, cobalt oxide (CoO), nickel metal, and optionally cobalt metal, with the zinc and cobalt oxides present, at least partially, in chemical mixture with the nickel hydroxide. Additionally a finely divided binder such as dry P.T.F.E. may be employed. This material provides the adhesion necessary for electrode structural integrity in the absence of CMC and an aqueous media. The dry blended materials are metered into compression rollers together with the three-dimensional carrier. As the powders fill the void space they are compressed to the appropriate porosity.

In certain embodiments, the composition of positive electrode employed in the dry mixing procedure is very similar to that employed in wet processes described above. However, the CMC binder is not used, and obviously much less water is employed as no paste or slurry is produced. In a specific embodiment, the dry positive electrode components are electrochemically active nickel (nickel hydroxide (Ni(OH)₂), nickel oxide and/or nickel oxyhydroxide), zinc oxide, cobalt oxide, and cobalt metal. Note that no binder is included here, as it will be introduced later in this embodiment. Mixing of the components may be accomplished using a mixing apparatus suitable for mixing powders or granular compositions. As an example, a mixer apparatus may employ blades, impact wheels, rollers, ribbons, internal screws, vibrating elements, and the like to effect even mixing. In an alternative embodiment, mixing is accomplished manually using, e.g., a spatula.

After the dry components have been mixed, a binder such as PTFE (polytetrafluoroethylene) may be added to a level of between about 0.1 and 5 percent by weight of the total dry mixture of positive electrode components. Other binder materials may be used in place of or in conjunction with PTFE. As binders, these materials “bind” the other components of the electrode to thereby hold them in place and minimize the likelihood of flaking or otherwise separating from the current collector. In certain embodiments, chosen binder materials are inert to the electrochemical environment of the positive electrode. That is, the binder materials do not decompose, melt, or diffuse out of the positive electrode during fabrication or during normal operation. In certain embodiments, such materials resist oxidation or other chemical degradation. Preferably, they will not generate carbon dioxide or carbonates. One example of a class of materials having members that can serve as useful electrode binders in accordance with embodiments of this invention is the fluorinated polyolefins.

The binder may be added in a dry state or as an emulsion, for example. In a specific embodiment, when the binder is a fluorinated polyolefin, it is provided as an emulsion comprising approximately 60 percent by weight binder. It is combined with the remainder of the components manually or by any suitable mixing apparatus (such as those identified above) to produce an evenly dispersed mixture that is subsequently heated to remove the moisture. In a manual process, the person responsible for mixing may use a spatula or similar tool to effect the mixing. In some embodiments, the binder and remaining components of the positive electrode are combined in a single step, as opposed to the two-stage procedure described above.

After the binder and other components of the positive electrode are combined in a well-mixed state, they are deposited in a dry state on a current collector or other carrier or substrate. In one embodiment, a foam or expanded metal current collector is employed for this purpose—e.g., a nickel foam having a density of between about 300 and 600 gm/m², and more preferably between about 450 and 500 gm/m².

The positive electrode mixture may be applied to the substrate by, for example, brushing, pressing, or the like, in a continuous fashion. In alternative embodiments, application is accomplished in a batch fashion, or in a semi-continuous fashion, whereby the mixture is applied to a “plaque” of substrate sufficient to form, for example, 8-10 cells. The plaque, with applied positive electrode material, is cut, scored, and otherwise processed to generate individual strips of electrode for assembly in the final cell.

Brushing may be accomplished by manually brushing in the electrode mixture with a brush and periodically checking to ensure the correct amount of positive electrode material has been incorporated in the current collector foam or other substrate material. To this end, the substrate and incorporated electrode material may be weighed from time-to-time until a set endpoint is reached. Brushing may also be automated using, for example, an apparatus having two or more brushes positioned on opposite sides of the substrate where they receive a supply of electrode material. As the substrate passes between the brushes, electrode material is drawn into substrate.

Thereafter, in accordance with an embodiment of this invention, the electrode material is compressed onto the substrate by an appropriate technique such as calendaring. In a specific embodiment, the electrode and carrier are passed vertically through calendaring rollers to produce a compressed electrode sheet of appropriate dimensions. In a specific embodiment, the resulting electrode has a thickness of between about 10 and 50 mils, or between about 20 and 30 mils.

After the material has been applied, an external coating may be applied. This step is appropriate if the electrode is susceptible to flaking, peeling, or easy separation of the active electrode material from the current collector or carrier. The coating serves to encapsulate the electrode material or at least reduce the likelihood that the material will separate from the carrier. In one embodiment, the coating comprises PTFE or physically similar material. In a specific embodiment, the electrode is dipped in or sprayed with an emulsion of the coating material (e.g., an emulsion of about 60 weight percent PTFE).

In certain embodiments, the resulting electrode and carrier assembly (whether coated or not) is subjected to “microcracking.” This is a process of bending the electrode sheet while under tension to introduce “microcracks” and thereby make the electrode more flexible. One apparatus for introducing microcracks employs offset rollers through the electrode sheet is pulled under tension.

In certain embodiments employing a continuous feed of carrier and deposition of electrode material, the carrier/electrode sheet must be periodically cut. In other embodiments, the carrier is sized to support positive electrodes for one or a pre-set number of cells. In the case where the carrier supports electrodes for a set number of cells (e.g., 8 cells), it is referred to as a plaque. After electrode material has been incorporated into the plaque, the plaque is cut into multiple individual electrode strips. In a specific embodiment, at least one such cut is made lengthwise along the plaque so that the cut defines a top portion one electrode strip and a bottom portion of another electrode strip, with the top and bottom designations referring to positions within an assembled cell.

Once the carrier sheet is coated with positive electrode material, the resulting sheet is dried (127), if necessary, to drive off excess water and then compressed (129). These process operations can be performed in much the same manner as operations 107 and 109 for the negative electrode. As can be appreciated by one skilled in the art and as noted above for the negative electrode, compression brings the electrode to a uniform desired thickness and porosity as described above for the negative electrode path. Preferably, the resulting positive electrode sheet has a thickness of between about 15 and 40 mils (e.g., about 25 mils) and has a porosity of between about 30 and 45%.

A similar process to that outlined above for the positive electrode may be applied to the negative electrode. The electroactive materials and other components will be different but the use of a binder and the basic process will follow the procedure set forth above.

After a positive electrode is prepared as described above, it may be tabbed and slit as indicated at a step 131. The slitting of the electrodes to width may be done before or after tabbing, however most automated lines slit the electrode stock after an in-line tabbing process. Tabbing of the coined edges facilitates the final welding of the current collector arrangement after winding of the jelly-roll. As indicated, the current collector (substrate) may be a nickel foam or other material having a large void fraction. To ensure that the current collector makes adequate electronic contact with the collector disk, the process may include applying the metal tab (e.g., a thin nickel sheet of about 0.08 to 0.15 inches width) along one lengthwise edge of the current collector. After rolling the tabbed positive electrode into a jellyroll, the tab makes contact with the collector disk by, e.g., soldering, welding, or pressure contact. The tab may be affixed to the edge of the current collector (where the wet or dry electrode mixture has not been applied) at various stages in the above process by, e.g., a seam welding process, a resistance welding process, or an ultrasonic welding process.

In certain embodiments, no tab is employed, even when using a high void volume current collector such as a nickel foam. In such a case the coined non-pasted area may be folded over to create a planar or generally planar surface that is more readily bonded to a current collector disc. In certain embodiments, the coined area may be cut to allow ease of bending. For example, sections may be cut away to leave multiple small tabbed sections. After bending, contact to the current collector plate or disc may be made either by resistance welding or by pressure contact. In these embodiments, the positive electrode jellyroll foam directly contacts the collector disk and no intermediate features such as a tab are employed. Application of this design in “reverse polarity” or negative cap design is described elsewhere herein.

At this point in the process, the two paths (negative electrode fabrication and positive electrode fabrication) converge to provide a layered arrangement of sheets that remain with the cell to completion. At the convergence point (represented as “A” in FIG. 1), multiple sheets of material are brought together and wound or otherwise assembled into a cell structure. In a particular example four sheets of separator material (depicted as sources 113 and 133) are interleaved with the positive electrode sheet and the negative electrode sheet. Thus, once the electrodes are fabricated, they are sandwiched between semi-permeable separator sheets (113, 133).

In an example embodiment, the separator for the positive electrode (113) comprises a plurality of sheets of a microporous polyolefin that may be commonly acquired as CELGARD™ line of separators from Celgard Inc. (Charlotville, N.C.) or SOLUPORE products from Solutech. The separator serves to mechanically isolate the positive and negative electrodes, while allowing ionic exchange to occur between the electrodes and the electrolyte. Thus, good permeability to the electrolyte is desirable. In an example embodiment, the separator for the negative electrode (133) comprises a nylon sheet. Other separator materials known in the art may be employed. As indicated, nylon-based materials and microporous polyolefins (e.g., polyethylenes and polypropylenes) are suitable.

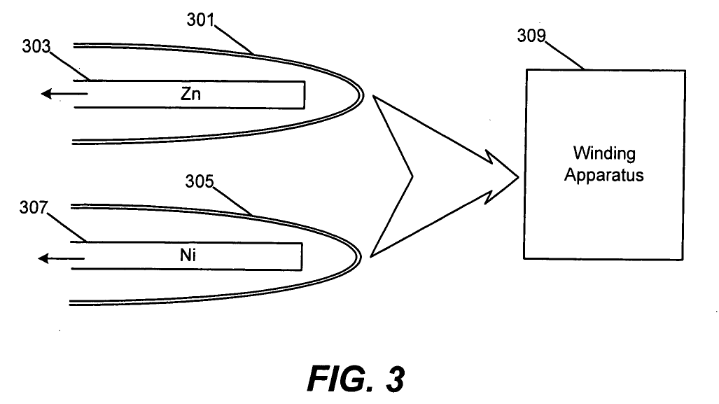

Turning briefly to FIG. 3, FIG. 3 is a cross-sectional representation of the positive and negative electrodes prior to winding. In the illustrated example, separators (301, 305) are initially folded over the electrodes (303, 307) along the electrode's planar surface before being drawn or fed, with the electrode sheets, into a winding apparatus 309. In this approach two sources of separator are employed. In an alternative embodiment, each electrode sheet is straddled by two separate sources of separator sheet so that four sources of separator, rather than two are employed. Thus, initially, a separator sheet is not folded over the leading edge of an electrode. However, the resulting layered structure is the same. Both approaches produce a structure in which two layers of separator separate each electrode layer from the next adjacent electrode layer. This is generally not the case with nickel cadmium cells, which employ only a single layer of separator between adjacent electrode layers. The additional layers employed in the nickel zinc cell help to prevent shorting that could result from zinc dendrite formation.

Dendrites are crystalline structures having a skeletal or tree-like growth pattern (“dendritic growth”) in metal deposition. In practice, dendrites form in the conductive media of a power cell during the lifetime of the cell and effectively bridge the negative and positive electrodes causing shorts and subsequent loss of battery function.

Note that the separator sheets generally do not entirely cover the full widths of the electrode sheets. Specifically, one edge of each electrode sheet remains exposed for attaching terminals at step 203. This is the edge that was wiped clean of electrode material at steps 111 and 131. Further, and for the same reason, the electrodes are offset laterally by approximately the width of the cleaned strip that was discussed above. This presents one lateral edge having only exposed negative current collector and the opposite lateral edge having only exposed positive current collector to accommodate terminal attachment in step 203.

The winding apparatus draws the various sheets in at the same time and rolls them into a jellyroll-like structure. After a cylinder of sufficient thickness is produced, the apparatus cuts the layers of separator and electrodes to produce the finished cell assembly.

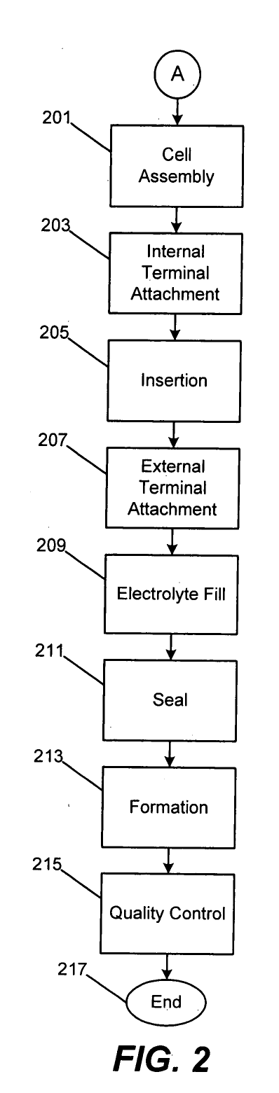

Turning to FIG. 2, a continuation of the process flow of FIG. 1 is shown. The process of FIG. 2 begins with a cell assembly 201 resulting from the assembling operation “A.” For cylindrical cells, this assembly is a jellyroll-like structure. In an alternative embodiment, it is a rectangular or prismatic layered structure. It can be appreciated by one skilled in the art that the form factor of the cell assembly is user dependent and may take any of a number of forms well known in the art. If a prismatic form is used, it may be desirable to pre-wrap the positive and negative electrode sheets in their own separators prior to assembly.

Once winding or other assembly of electrode layers and interleaved separator layers is complete, separate internal terminals are conductively attached (203) to each of the negative electrode and the positive electrode. More specifically, a positive terminal is conductively attached to the exposed positive current collector at one axial end of the cell assembly and a negative terminal is conductively attached to the exposed negative current collector at the other axial end of the cell assembly. Attachment of the internal terminal may be accomplished by any method well known in the art such as spot welding, ultrasonic welding, laser welding, soldering, pressure contacting, or any other type of electro-conductive bonding appropriate for the terminal and current collector materials. Specific approaches for attaching a copper internal terminal are described below.

In one embodiment of the present invention, the internal terminals comprise disks, which may or may not be perforated or slotted. In another embodiment, the internal terminals comprise H-shaped structures. Regardless of their actual structure, the internal terminals may be conductively attached to the electrodes without requiring tabs to be present on the electrode with which an internal terminal may attach.

After the internal terminals are attached, the cell assembly is inserted into a retaining vessel (205) such as a can in the case of a cylindrical cell assembly. The can or other vessel serves as the outer housing or casing of the final cell. With the cell assembly in the can, the terminal disks (or other internal terminals) can be conductively attached to the cell's can and lid or other external terminals at step 207.

The external terminals provide direct electrical access to the power cell for a powered device. As such, the external terminals, in some embodiments, are preferably plated with a non-corrosive metal such as nickel plate. Further, the external terminals may function to isolate the electrodes from mechanical shock. Given the portable nature of electronic devices, the likelihood of mechanical shock is reasonably high. If the external terminals were directly attached with the electrode current collectors, significant failure of the welded joint or direct damage to the electrodes might occur.

In a next step 209, an appropriate electrolyte is provided. Of particular relevance to the present invention, the electrolyte should possess a composition that limits dendrite formation and other forms of material redistribution in the zinc electrode. Such electrolytes have generally eluded the art. But one that appears to meet the criterion is described in U.S. Pat. No. 5,215,836 issued to M. Eisenberg on Jun. 1, 1993, which is hereby incorporated by reference. A particularly preferred electrolyte includes (1) an alkali or earth alkali hydroxide present in an amount to produce a stoichiometric, excess of hydroxide to acid in the range of 2.5 to 11.0 equivalents per liter, (2) a soluble alkali or earth alkali fluoride in an amount corresponding to a concentration range of 0.01 to 1.0 equivalents per liter of total solution, and (3) a borate, arsenate, and/or phosphate salt (preferably potassium borate, potassium metaborate, sodium borate, and/or sodium metaborate). In one specific embodiment, the electrolyte comprises 4.5 to 10 equiv/liter of potassium hydroxide, from 2.0 to 6.0 equiv/liter boric acid or sodium metaborate and from 0.01 to 1.00 equivalents of potassium fluoride. A currently preferred electrolyte for high rate applications comprises 8 equiv/liter of hydroxide, 4.5 equivalents of boric acid and 0.2 equivalents of potassium fluoride.

The invention is not limited to the electrolyte compositions presented in the Eisenberg patent. Generally, any electrolyte composition meeting the criteria specified for the applications of interest will suffice. Assuming that high power applications are desired, then the electrolyte should have very good conductivity. Assuming that long cycle life is desired, then the electrolyte should resist dendrite formation. In the present invention, the use of borate and/or fluoride containing KOH electrolyte along with appropriate separator layers reduces the formation of dendrites thus achieving a more robust and long-lived power cell.

In a specific embodiment, the electrolyte composition includes an excess of between about 3 and 5 equiv/liter hydroxide (e.g., KOH), NaOH, LiOH. This assumes that the negative electrode is a zinc oxide based electrode. For calcium zincate negative electrodes, alternate electrolyte formulations may be appropriate. In one example, an appropriate electrolyte for calcium zincate has the following composition: about 15 to 25% by weight KOH, about 0.5 to 5.0% by weight LiOH.

Various techniques may be employed to fill the vessel with electrolyte. In one example, the electrolyte is introduced via an injection process in which electrolyte enters the cell via a fill port. In other cases the electrolyte may be added prior to lid application and the cell is spun to distribute the fluid.

After the can or other containment vessel is filled with electrolyte, the vessel is sealed to isolate the electrodes and electrolyte from the environment. See block 211. As can be appreciated by one skilled in the art, any of a number of sealing methods may be utilized including, but not limited to crimping, welding, stamping, or gluing. Note that in a cylindrical cell, the lid is typically seated on a gasket residing on a circumferential bead in the upper portion of the can. To effect sealing, the top edge of the can is then crimped down toward the lid without making electrical contact.

Although the cell is generally sealed from the environment, the cell may be, in some embodiments, permitted to vent gases from the battery that are generated during charge and discharge. A typical nickel cadmium cell vents gas at approximately 200 PSI. In some embodiments, a nickel zinc cell is designed to operate at this pressure and even higher (e.g., up to 300 PSI) without the need to vent. This may encourage recombination of any oxygen and hydrogen generated within the cell. Preferably the cell is constructed to maintain an internal pressure of not greater than about 600 PSI and more preferably not greater than about 450 PSI. In other embodiments, a nickel zinc cell is designed to vent gas at relatively lower pressures. This may be appropriate to release hydrogen and/or oxygen gases rather than encourage their recombination within the nickel zinc cell. A vent mechanism is preferably designed to allow gas escape but not allow electrolyte passage that may interfere with the reproducible function of the vent. The use of hydrophobic membranes can be effective for this purpose (see e.g., U.S. patent application Ser. No. 10/098,193, “Leak Proof Pressure Relief Valve for Secondary Batteries,” filed Mar. 15, 2002 for J. Phillips, which is incorporated herein by reference for all purposes) and these may be used alone or in conjunction with a tortuous gas escape route. Many other battery venting mechanisms are known in the art and are suitable for use with this invention.

To prepare a cell for use typically requires one or more “formation” cycles to modify the electrode structure. In FIG. 2, formation of the cell is accomplished at step 213. A formation cycle follows a specific voltage-current-time curve that accounts for factors such as electrode composition and cell capacity. In a typical case, formation is accomplished using a large power supply that charges numerous cells at once over a period of, for example, about 24 to 74 hours.

In a specific example, formation and related operations may be performed as follows. The cells are vacuum filled with electrolyte and soaked for less than 2 hours (for comparison, nickel cadmium cells are generally soaked for 24 hours but are usually drip filled). Before the 2 hour period is up the cells are placed on formation charge where a net 100%-150% of the theoretical capacity is input over 24-60 hours. The formation protocol includes a discharge and recharge step that is believed to help distribute electrolyte, but this example can be practiced without this operation. In another example, the mid-formation discharge is eliminated. Cells may be charged singly or with two in series, but in a production environment it is more usual to charge the cells in larger series strings. During formation, one may monitor the voltage behavior over the complete formation process and collect weight loss, impedance values and open circuit voltages to classify and identify possible weak cells.

Once formation is complete, every cell is discharged during a quality control step 215 to determine the particular capacity of each cell. Cells having similar capacities are grouped for use in the same battery packs. In this way, each cell in a battery pack becomes fully charged after receiving substantially the same quantity of charge. Thus, when charge is complete no cell in the pack is significantly under utilized and no cell in the pack is significantly overcharged. Groupings of batteries may be restricted to two or more groupings depending on the nature and sensitivity of the application.

Note that the operations of FIG. 2 are generally the same as or very similar to corresponding operations employed in the manufacture of nickel cadmium cells. Hence, the apparatus employed for these operations in nickel cadmium cell fabrication generally can also be used in nickel zinc cell fabrication. Note, however, that the electrode, current collector, and electrolyte differences may require customized apparatus or processing. For example, the zinc electrode may employ a copper current collector, which cannot be employed with a cadmium electrode. While copper has better electronic conductivity than steel, it can present fabrication issues. For example, attaching a current collecting copper disk to the copper sheet may require specific laser welding settings and the appropriate jigs to provide continuous pressure during the weld.

Nickel zinc cells prepared in accordance with this invention may have particularly useful properties for power tool and UPS applications. For example, energy densities will exceed about 60 Wh/kg and continuous power densities are commonly in excess of about 500 W/kg or even 1000 W/kg.

In another embodiment of the present invention, the polarity of the cell's terminals is reversed in comparison to conventional cells for consumer electronics. Many of the same methods of manufacture described herein are utilized to accomplish this embodiment with minor variations that are herein described. In conventional power cell manufacturing, the polarity of the cell is established wherein the lid is positive and the can or vessel is negative. That is, the positive electrode of the cell assembly is electrically connected with the lid and the negative electrode of the cell assembly is electrically connected with the can that retains the cell assembly. Notably, the lid is electrically isolated from the can through the use of a flexible gasket and a bituminous sealing agent.

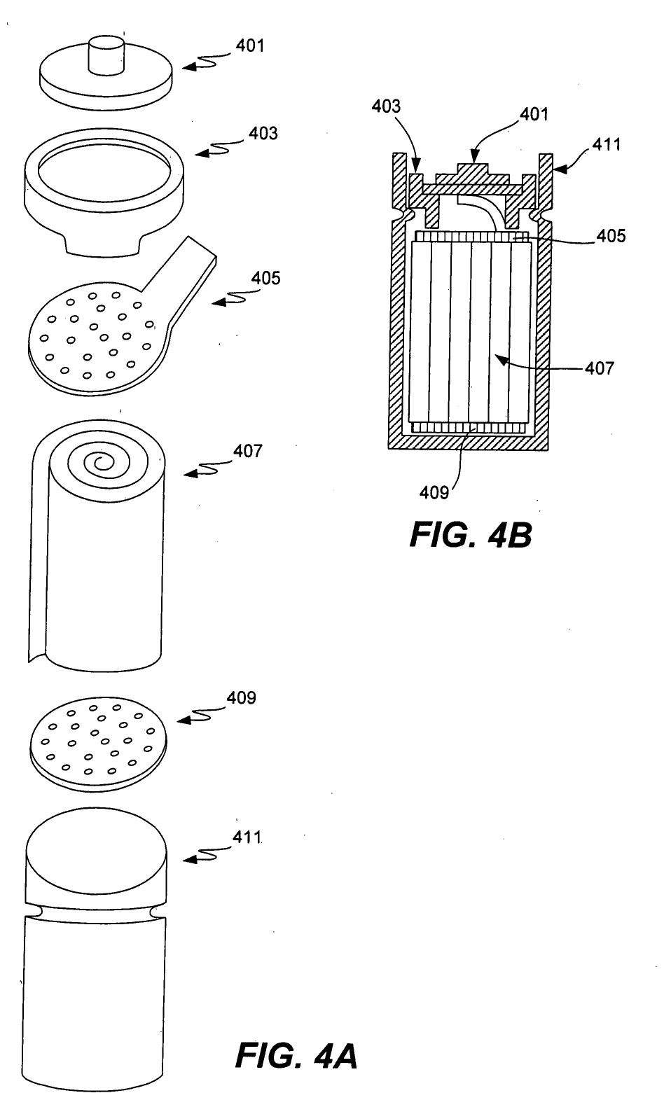

Turning to FIG. 4a, FIG. 4a is a graphical representation of a reverse polarity power cell sub assembly embodiment. A cell assembly (407) is manufactured using the techniques provided herein. A negative internal terminal (405) is electrically connected with the negative electrode of the cell assembly. Because of the unique properties of Nickel/Zinc electrochemistry, the negative internal terminal (405) is preferably comprised of copper. Typically, conventional power cells exhibit an overall impedance of approximately 3 to 5 milliohms. Approximately 0.8 milli-Ohm may be attributed to the positive current collector and the resistance weld to the cap. This is due in part to the compositional requirements of the terminal given the electrochemistry of conventional power cells. In the present embodiment, the use of copper in the manner described results in a significant impedance reduction of approximately 0.5 milli-Ohm at the now negative terminal thus achieving a more power efficient cell. One skilled in the art will appreciate that slightly higher impedance cells may be constructed by coating or plating the interior surface of the retaining vessel (411) with copper, and subsequently making contact to the negative current collection disc, although this method would necessitate alternative manufacturing steps.

Importantly, copper, in this and other embodiments, requires particular attention when used as an internal terminal. In particular, copper, as is well known in the art, is particularly effective, not only in carrying current, but also in conducting heat. As such, the electrical attachment of the internal terminal with the negative electrode requires specific manufacturing techniques. In an example embodiment, the copper internal terminal is perforated and attached at multiple points along the negative electrode so that the electrode is attached to the current collector at multiple points along its length. By activating a greater area, the charge and discharge efficiency is further enhanced. The perforations also serve to locate the electrode and allow electrolyte to penetrate the stack uniformly during the electrolyte fill operation. In another embodiment, the internal terminal is slotted to achieve the named advantages.

Further, as noted above, copper is particularly efficient in conducting heat requiring novel techniques of attaching the internal terminal with the negative electrode to avoid damaging the negative electrode. Notably, these novel techniques may be used in conjunction with other techniques well known in the art such as spot welding, ultrasonic welding, laser welding, non-welding heat bonding (e.g., soldering), compression bonding, or any other type of electro-conductive bonding appropriate for the terminal and current collector materials.

In one preferred embodiment, laser welding is employed to form a low impedance connection between the internal terminal and the copper current collector. In a specific approach, the laser welding is performed in cross fashion or other tracking method that maximizes the number of weldments, in which the laser is moved across the surface of the internal terminal to catch each point. It has been found that good welds can be achieved using laser pulses with a 600 micron beam diameter having a power of between about 0.2 and 5 kW, pulse widths of between about 0.5 and 4 milliseconds and pulse frequencies of between about 1 and 20 Hz. These power levels and duty cycles can be achieved with a pulsed Nd:YAG laser such as model number LW70A from Unitek Miyachi Corporation. In one approach, wound nickel-zinc jelly rolls are inserted into a jig where the copper current collection disc is pressed onto the exposed copper edges of the negative electrode. The laser beam is then programmed to lap weld the connections as it traverses the end of the jelly-roll. The required power levels are dependent on the thickness of the copper electrode substrate and the thickness of the current collection disc. The former is normally between 0.002-0.005 inches and the latter is between 0.002-0.01 inches depending on the cell size and current carrying capability.

Another embodiment employs soldering to bond a copper internal terminal to copper sheet of the jelly-roll. The internal terminal and the jelly-roll are brought into contact at a temperature that causes soldering. In certain embodiments, a thin layer of a solderable metal is applied to the internal terminal. It may be applied over one or both faces of the terminal coating the entire face(s) or just specific regions thereof. The metal may be applied by electroplating, electroless plating, high temperature contact with the metal, etc. The chosen metal should be electrochemically compatible with the zinc electrode and resist corrosion when contacting electrolyte at potentials typically encountered during overcharge and over-discharge. In a specific example, the internal terminal is coated on at least one face with tin or a tin alloy having a thickness of between about 0.0002 and 0.002 inches.

In another embodiment, the contact is made by compression between the internal terminal and the copper of the jelly-roll. Such compression may be provided by downward force provided by the cell cap in the fully assembled cell. To couple the cap to the internal terminal, some embodiments employ a O-ring or other elastomeric member or a metallic spring device interposed between the cap and the internal terminal. In a specific embodiment, the internal terminal is provided as a folded unitary member having one wing contacting the jelly-roll and another wing contacting the cell cap. An O-ring or other elastomeric member or copper plated stainless steel spring is located between the two wings of the internal terminal so that when the cell cap is positioned it transfers downward force from one wing of the terminal to the O-ring and onto the second wing of the terminal, which abuts the jelly-roll.

Returning to FIG. 4a, the positive internal terminal (409) is electrically connected with the positive electrode using techniques well known in the art. The power cell fabrication then proceeds using the manufacturing techniques described herein. For illustrative purposes, FIG. 4b is presented to further clarify the embodiment described above. In particular, FIG. 4b is a graphical cross-sectional representation of a reverse polarity power cell sub assembly embodiment. Notably, FIG. 4b illustrates the position of the insulating gasket (403) that serves to electrically isolate the negative external terminal (i.e. the lid (401)) from the positive external terminal (i.e. the can (409). It is contemplated that a variety of materials may be used to achieve electrical isolation in the present embodiment.

The foregoing describes the instant invention and its presently preferred embodiments. Numerous modifications and variations in the practice of this invention are expected to occur to those skilled in the art. Such modifications and variations are encompassed within the following claims.

The entire disclosures of all references cited herein are incorporated by reference for all purposes.

What is claimed is:

1. A rechargeable power cell, said method comprising:
a first electrode sheet comprising a zinc negative electrode material on a first conductive carrier;
a second electrode sheet comprising a nickel positive electrode material on a second conductive carrier;
at least one separator sheet between the first electrode sheet and the second electrode sheet such that the first electrode and the second electrode sheets and the at least one separator sheet form are layered to form a cell assembly; and
an electrolyte comprising (a) 4.5 to 10 equiv/liter of an alkali hydroxide, (2) a soluble alkali or earth alkali fluoride in an amount corresponding to a concentration range of 0.01 to 1 equivalents per liter of total solution, and (3) 2.0 to 6.0 equiv/liter of a phosphate salt.
